(19) United States
(12) Patent Application Publication
(10) Pub. No.: US 2008/0038443 A1
(43) Pub. Date: Feb. 14, 2008

(54) Process for preparing potato products having reduced trans-fat levels

(76) Inventors: Dwane Bert Benson, Payette, ID (US); Hershall Johnson, Weiser, ID (US); Susan Farnsworth, Fruitland, ID (US)

Correspondence Address: BUCHANAN, INGERSOLL & ROONEY PC, POST OFFICE BOX 1404, ALEXANDRIA, VA, 22313-1404, US

(21) Appl. No.: 11/500,915

(22) Filed: Aug. 9, 2006

(51) Int. Cl. A23L 1/216

(52) U.S. Cl. 426/637

(57) ABSTRACT

A process for producing frozen potato products having reduced trans-fat levels comprising the steps of: providing a stable frying oil with an 18:3 ratio of <2 wt % and a trans-fat level of <3 wt %; par frying potatoes in the blend to produce potato products; and freezing the potato products to produce frozen potato products having reduced trans-fat levels, wherein ≧50% of the oil remaining in and on the frozen potato products freezes at temperatures ≧10° F.

### TECHNICAL FIELD

This invention broadly concerns a process for preparing frozen potato products. More particularly, this invention relates to a process for preparing potato products using a stable frying oil with reduced trans-fat levels and high crystallization temperatures. Exemplary blends of cooking oils having stable frying characteristics, reduced trans-fat levels, and increased crystallization temperatures are described herein.

### BACKGROUND

Traditionally, frozen potato products are prepared by par frying potato products, then freezing the par fried potato product in a freezing tunnel, and then storing the frozen potato product in frozen storage. Frozen potato products have traditionally been par fried in an oil having a crystallization temperature (i.e., freezing temperature) that is either within the temperature range of the freezing tunnel or higher. For example, potato products are often frozen in freezer tunnels at temperatures ranging from about 10° F. to about 25° F. By providing oil with this “high” crystallization temperature, both the potatoes and residual frying oil can be frozen in the freezing tunnel, where the potatoes are individually quick frozen. By freezing potato products and residual cooking oil in the freezing tunnel, residual cooking oil on the frozen potato pieces is normally in a solid, rather than liquid, state prior entering frozen storage.

While temperatures in a freezing tunnel may be sufficient for freezing the potato products, those temperatures may still be too high for a low trans-fat oil, which can have a freezing temperature/crystallization temperature of around 5° F. Thus, while the potato product is frozen, the low trans-fat oils on these frozen products remain liquid when leaving the freeze tunnel and entering frozen storage. The liquid state of such oil presents a problem because, after the frozen potato product is put into packages or bulk totes for storage, the frozen potato products are often then placed into much colder freezers for frozen storage (i.e., around 0° F. freezers) and this colder temperature then causes any liquid oil to crystallize.

Many high crystallization temperature oils (e.g., partially hydrogenated oil) have substantial trans-fat contents. On the other hand, stable frying oils with low trans-fat levels typically exhibit low crystallization temperatures. These low crystallization temperatures can cause clumping of the products. This clumping is due to the low crystallization temperature oils remaining in liquid form after processing in the freeze tunnels and only freezing in frozen storage. Thus, the frozen potato products freeze together or “clump” to form masses of potatoes that must be broken for further packaging or consumer use. Thus, when making frozen potato products, this low level of crystallization temperature of zero trans-fat containing oils can create problems.

Weight-bearing pressure from other products or cases stacked on top of one another exacerbates clumping during freezing of oil in frozen storage. This applied pressure during the crystallization of the oil can cause the oil to act as an adhesive between potato products and in turn can cause the potato products to stick together and “clump.”

This sticking or clumping can cause issues for the consumer product because the potato product can turn into a solid mass, wherein a consumer would have to break up the clumps in order to cook the product. This sticking or clumping can also cause issues for the manufacturer because if the product is in a bulk tote in a factory setting, then large amounts of product (e.g., about 1000 lbs.) can be stuck together. With such large clumps, as one would imagine, the difficulty of breaking up the clumps is even greater.

### SUMMARY

To provide frozen potato products having reduced trans-fat levels and reduced clumping, a process for preparing potato products is provided herein. In an exemplary embodiment, a blend of sunflower oil and a second oil selected from the group consisting of cottonseed oil and palm oil is used on potatoes for providing frozen potato products with reduced trans-fat levels and reduced clumping.

An exemplary process for producing frozen potato products having reduced trans-fat levels comprises the steps of providing a stable frying oil with an 18:3 ratio of <2 wt % and a trans-fat level of <3 wt %; par frying potatoes in the blend to produce potato products; and freezing the potato products to produce frozen potato products having reduced trans-fat levels, wherein ≧50% of the oil remaining in and on the frozen potato products freezes at temperatures ≧10° F.

An exemplary process for preparing frozen potato products having reduced trans-fat levels comprises the steps of providing a blend of oil consisting essentially of a first oil and a second oil, wherein the first oil consists essentially of sunflower oil and wherein the second oil consists essentially of cottonseed and/or palm oil; par frying potatoes in the blend to produce potato products; and freezing the potato products to produce frozen potato products having reduced trans-fat levels.

Another exemplary process for providing frozen potato products having reduced trans-fat levels and reduced clumping comprises the steps of providing a blend of sunflower oil and a second oil, wherein the crystallization temperature of the second oil is greater than about 25° F.; par frying potatoes in the blend to produce potato products; and freezing the potato products to provide frozen potato products having reduced trans-fat levels and reduced clumping.

### BRIEF DESCRIPTION OF THE DRAWINGS

FIG. 1 is a graph of oil crystallization temperatures for exemplary oils and blends of oils; and

FIG. 2 is a graph of oil crystallization temperatures for exemplary oils and blends of oils after the oils and blends of oils have been “slightly used” or “broken in”.

### DETAILED DESCRIPTION

Provided herein is an exemplary process for producing frozen potato products having reduced trans-fat levels comprises the steps of providing a stable frying oil with an 18:3 ratio of <2 wt % and a trans-fat level of <3 wt %; par frying potatoes in the blend to produce potato products; and freezing the potato products to produce frozen potato products having reduced trans-fat levels, wherein ≧50% of the oil remaining in and on the frozen potato products freezes at temperatures ≧10° F.

Additionally, provided herein is an exemplary process for preparing potato products having reduced trans-fat levels by providing a blend of sunflower oil and a second oil selected from the group consisting of cottonseed oil and palm oil. By providing a combination of sunflower oil and a second oil, reduced trans-fat as well as reduced clumping of frozen potato products can be achieved.

As used herein, “crystallization temperature” is intended to include an approximate temperature at which crystallization of a liquid begins. In other words, the crystallization temperature of an oil is the warmest temperature at which crystals begin to form in the oil rather than the colder temperature in which the entirety of the oil has crystallized.

As also used herein, a “low” crystallization temperature oil is intended to include oils which crystallize at temperatures below the temperatures reached in a freeze tunnel (e.g., about 10° F. to about 25° F.). On the other hand, “high” crystallization temperature is intended to include oils which crystallize at temperatures which are above those temperatures reached in a freeze tunnel.

Sunflower oil has very low saturated levels and approximately 0 grams trans-fat; however, sunflower oil has a low crystallization temperature of about 5° F. Thus, temperatures of exemplary freeze tunnels in the range of about 10° F. to about 25° F. would not freeze or solidify the sunflower oil, and the sunflower oil remains liquid when exiting the freeze tunnels. In other words, sunflower oil only freezes at lower temperatures, such as that provided in frozen storage at temperatures of about 0° F. This freezing, as mentioned above, causes the sunflower oil to freeze while the potato products are under weight-bearing pressure, and thus causes clumping during frozen storage.

One exemplary sunflower oil is NuSun™, which is registered by The National Sunflower Association. NuSun™ sunflower oil is stable without partial hydrogenation. NuSun™ oil is a mid-oleic sunflower oil with lower levels of saturated fat (less than 10%) than linoleic sunflower oil and with higher oleic levels (55-75%) (the majority of the remainder being linoleic (15-35%)), along with the zero trans-fat that is provided by other sunflower oils. Compared to conventional sunflower oil, it is noted that NuSun™ provides superior stability for frying (i.e., less oil breakdown and thus less off-flavoring by the oil) because of its higher oleic levels and lower linoleic levels, while also providing the desirable low levels of saturated fat and trans-fat; however it also has a low crystallization temperature similar to other sunflower oils, which can cause clumping during frozen storage.

On the other hand, oils with high crystallization temperatures often have undesirable trans-fat levels. Thus, while clumping can be reduced using oils with high crystallization temperature, these oils are less desirable because of their fat content profiles.

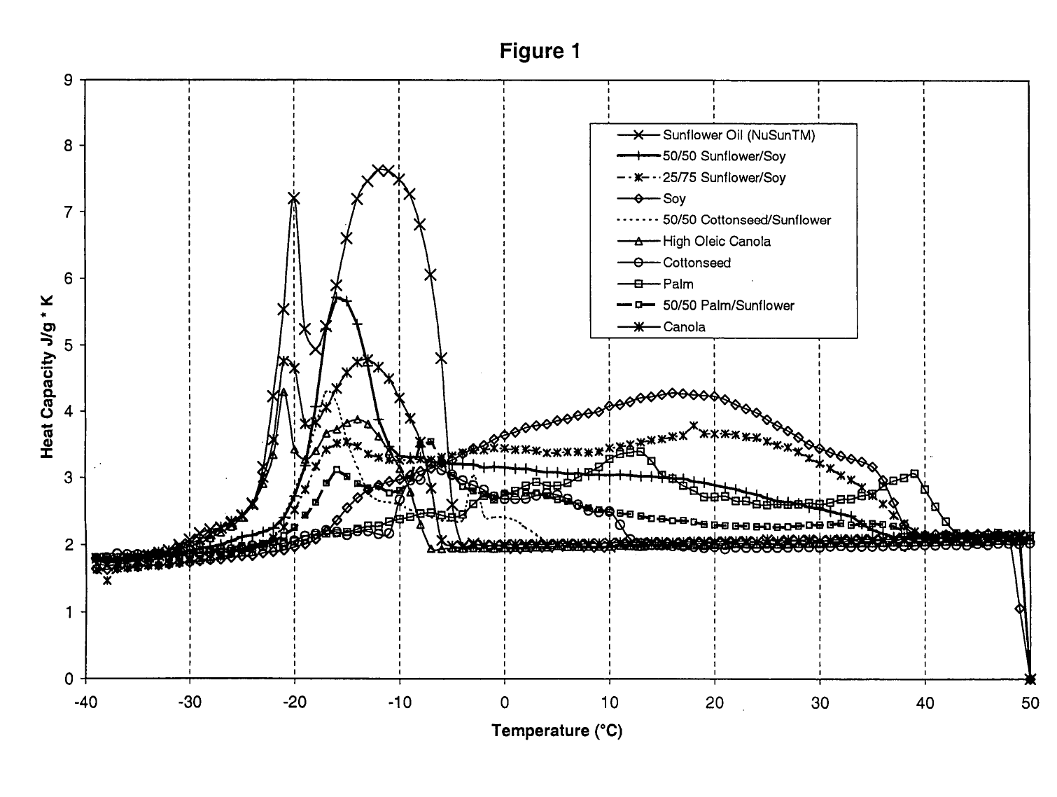

As illustrated in FIG. 1, various oils have various crystallization temperatures based on measurements using a Differential Scanning Calorimeter (DSC). The heat capacity using the DSC is measured by determining the amount of energy required to change the temperature of the tested oil.

The crystallization temperatures, as used herein, are based upon a phase change from liquid to solid of the oils illustrated. The phase change is represented by changes in slope of a curve, with the crystallization temperatures being determined approximately where a defined change occurs in slope of the curve. The crystallization temperatures are approximate temperatures because oils, similar to other organic compounds, have a range for phase change and thus the approximate initial change in heat capacity is used herein to approximate the crystallization temperature. Preferably, exemplary embodiment oils used herein initiate solidification at temperatures of at least 10° F. Also, in exemplary embodiments, at least 50% of the residual oil in frozen potato products freezes at temperatures of 10° F. or higher.

For example, as shown in FIG. 1, cottonseed oil has a large range of temperatures in which solidification occurs; however, initially at about 10° C. (50° F.) the slope of the graph changes indicating a phase change of liquid to solid, and thus defines the approximate crystallization temperature of cottonseed oil. Similarly, as also shown in FIG. 1, palm oil has an even larger range of temperatures in which solidification occurs (e.g., from about 40° C. (104° F.) to about −15° C. (5° F.)); however, initially at about 40° C. the slope of the graph changes indicating a phase change of liquid to solid, and thus defines the approximate crystallization temperature of palm oil.

As illustrated in FIG. 1, cottonseed oil has a high crystallization temperature of about 10° C. or 50° F., palm oil has a high crystallization temperature of about 40° C. or 104° F., sunflower oil (i.e., NuSun™ oil) has a low crystallization temperature of about −5° C. or 23° F., canola oil has a low crystallization temperature of about −10° C. or 14° F., a 50/50 blend of palm oil and sunflower oil has a high crystallization temperature of about 35° C. or 90° F., and a 50/50 blend of cottonseed oil and sunflower oil has a high crystallization temperature of about 0° C. or 32° F. Therefore, to provide high crystallization temperature, sunflower oil and canola oil would not work, while cottonseed oil, palm oil, and blends of sunflower and either palm or cottonseed oil would have the requisite high crystallization temperatures.

As also illustrated in FIG. 1, and as mentioned above, palm oil has a large range of temperatures in which solidification occurs. Due to this large range of temperatures, palm oil can be classified as a “plastic” type of oil in that it will not turn into a “hard” solid. Rather, palm oil remains pliable and frangible, which can aid in the production of frozen potato products because if clumping does occur, the clumps should be easier to break. Additionally, palm oil, similar to cottonseed oil for example, does not require hydrogenation for use in frying. Thus, palm oil and cottonseed oil do not have trans-fats.

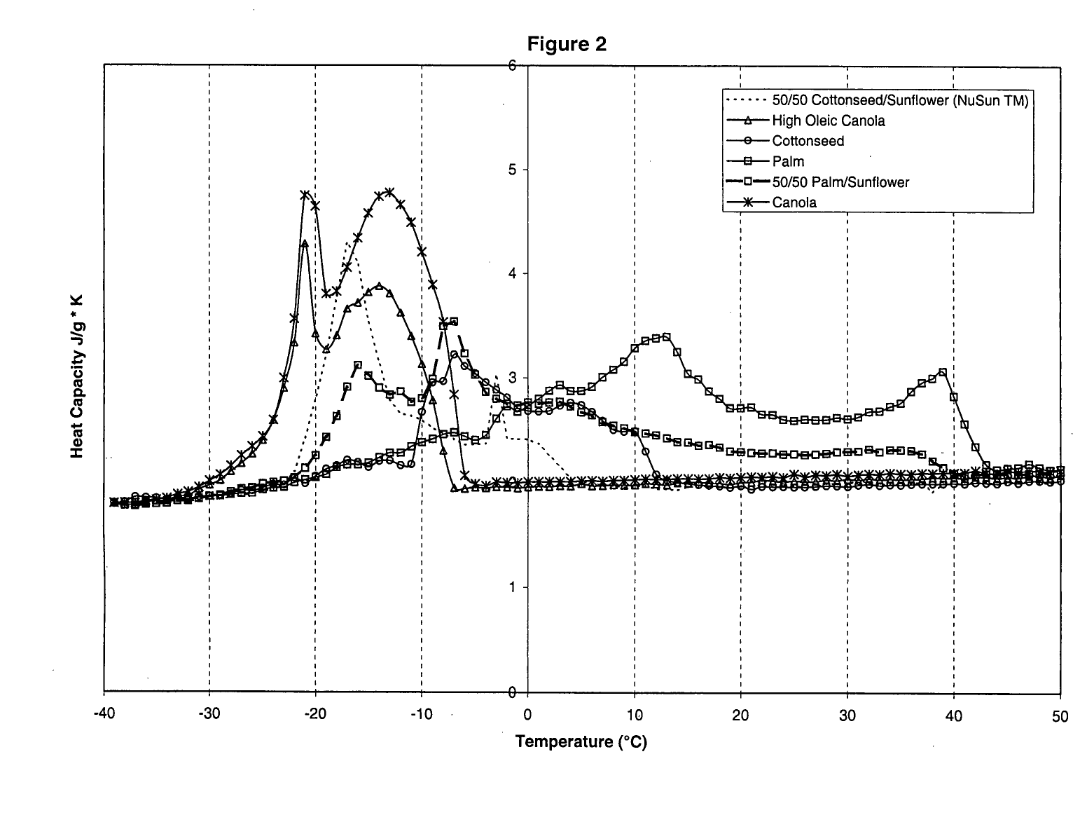

Similarly, in FIG. 2, which illustrates a “slightly used” or “broken in” set of oils, the heat capacities of the oils, and thus the crystallization temperatures appear relatively unchanged. Thus, FIG. 2 shows that after the oil has been used to par fry potatoes, the crystallization temperatures do not appear to have been affected by the use. It is noted that the free fatty acid in the “fresh” oil illustrated in FIG. 1 is about 0.05, while the free fatty acid in the “broken in” oil is about 0.6 to 0.8.

In addition to providing an oil that can freeze in a freeze tunnel, it is also desired to provide an oil that can remain frozen at temperatures above the temperatures in a freeze tunnel. This is desired because after exiting a freeze tunnel, frozen potato products are often collected into large bins. During this collection of frozen potato products in the bins, the bins and the frozen potatoes being loaded into the bins are often both held at room temperature or colder for short periods of time, which can lead to melting of the frozen oil on surfaces of the potatoes, and more importantly to the defrosting of the oil, which can lead to clumping during subsequent freezing. Thus, to reduce clumping at this stage, high crystallization temperature oils and blends are further desired.

After the bins are full, the bins are transported to frozen storage, wherein if the oil has melted and become liquid, then this will cause clumping during freezing in frozen storage due to the decreased temperature and the possible weight-bearing pressure applied by other products in storage.

Therefore, the cottonseed oil mixed with sunflower oil is desirable because (i) cottonseed oil can be crystallized within the freezing tunnel at temperatures less than 50° F. even though the sunflower oil remains liquid above 5° F., and (ii) the crystallization temperature of cottonseed oil is closer to room temperature it will remain in frozen or crystalline form.

In providing oils with higher crystallization temperatures, the crystallization temperature between these oils and the sunflower oil cannot be too disparate for miscibility purposes. While it is important to provide a blend that allows for crystallization from about 10° F. to about 25° F., the crystallization temperatures of the oils must be close enough to provide sufficient levels of miscibility to reduce separation of oil in the blend and thus the potential for clumping by the separated sunflower oil.

Additionally, exemplary oils are provided at temperatures above their melting temperatures prior to par frying such that the oils can remain in liquid form and can remain mixed. For example, cottonseed oil has a crystallization temperature of about 50° F. By blending cottonseed oil with sunflower oil, which has a crystallization temperature of about 5° F., the cottonseed oil can freeze at a much higher temperature—well above the temperature for a freeze tunnel.

On the other hand, if hydrogenated soy, for example, which has a crystallization temperature of about 135° F. is used in combination with sunflower oil, this dissimilarity in crystallization temperature could not be blended adequately enough such that they react as one oil.

Profiles for exemplary oils and blends of oils are listed in Table 1. In Table 1, the profiles include saturated fat (“SF”) content, trans-fat (“TF”) content and levels of linolenic acid (“18:3,” referring to 18 carbons and 3 double bonds, which indicates the oil's stability as a frying oil; where the higher levels are more unstable for frying) for various exemplary oils and blends of oils. Table 1 also lists the oils and blends of oils at different ratios, wherein the first row illustrates a 25/75 blend, the second row illustrates a 50/50 blend, and the third row illustrates a 75/25 blend. Preferably, oils used herein have an 18:3 level of <2 wt % for frying stability and <3 wt % trans-fat. Even more preferably, exemplary oils used herein may have a trans fat level of <1 wt % and/or an 18:3 level of <1 wt %.

Table 1 includes many oils and blends of oils. Noting specifically NuSun™ in combination with various oils for saturated fat, trans-fat and 18:3 profiles, it appears that the best combinations would be NuSun™ with corn oil, cottonseed oil, and palm oil because they provide low saturated fat and trans-fat levels, while also providing low 18:3 profiles. While it is noted that cottonseed oil and palm oil have desirably low crystallization temperatures, as illustrated in FIGS. 1 and 2 and as previously discussed, cottonseed oil and palm oil have increased saturated fat levels.

As mentioned above, the blend of cottonseed oil with sunflower oil can be used to provide a higher crystallization temperature than NuSun™ alone, and as shown in Table 1, exhibits reduced saturated fat and trans-fat levels. Additionally, a 50/50 blend of cottonseed oil in combination with NuSun™ has a crystallization temperature of about 0° C. or 32° F., to provide reduced trans-fat levels with crystallization temperatures high enough to prevent clumping during freezing and melting during high volume storage. Additionally, a combination of cottonseed oil and palm oil can be combined with sunflower oil to provide reduced trans-fat levels with increased crystallization temperature. Thus, a blend of cottonseed oil with NuSun™ would be desirable.

TABLE 1
Summary

| | PHSO† | | | W. PHSO†† | | | Soybean | | | Canola | | | Canola CV65‡ | | | Canola HO [symbol] | | |
|---|---|---|---|---|---|---|---|---|---|---|---|---|---|---|---|---|---|---|
| | SF | TF | 18:3 | SF | TF | 18:3 | SF | TF | 18:3 | SF | TF | 18:3 | SF | TF | 18:3 | SF | TF | 18:3 |
| 25%/75% | | | | | | | | | | | | | | | | | | |
| PHSO† | 17.6 | 38.0 | 0.5 | 15.2 | 20.6 | 2.7 | 16.0 | 9.5 | 6.0 | 10.3 | 9.5 | 6.9 | 8.9 | 9.5 | 2.4 | 9.4 | 9.5 | 2.8 |
| W. PHSO†† | 16.8 | 32.2 | 1.2 | 14.5 | 14.8 | 3.4 | 15.2 | 3.7 | 6.7 | 9.5 | 3.7 | 7.6 | 8.1 | 3.7 | 3.1 | 8.6 | 3.7 | 3.5 |
| Soybean | 17.1 | 28.5 | 2.3 | 14.7 | 11.1 | 4.5 | 15.5 | 0.0 | 7.8 | 9.7 | 0.0 | 8.7 | 8.4 | 0.0 | 4.2 | 8.9 | 0.0 | 4.6 |
| Canola | 15.2 | 28.5 | 2.6 | 12.8 | 11.1 | 4.8 | 13.6 | 0.0 | 8.1 | 7.8 | 0.0 | 9.0 | 6.5 | 0.0 | 4.5 | 7.0 | 0.0 | 4.9 |
| Canola CV65‡ | 14.7 | 28.5 | 1.1 | 12.3 | 11.1 | 3.3 | 13.1 | 0.0 | 6.6 | 7.4 | 0.0 | 7.5 | 6.0 | 0.0 | 3.0 | 6.5 | 0.0 | 3.4 |
| Canola HO [symbol] | 14.9 | 28.5 | 1.3 | 12.5 | 11.1 | 3.5 | 13.3 | 0.0 | 6.7 | 7.5 | 0.0 | 7.6 | 6.2 | 0.0 | 3.1 | 6.7 | 0.0 | 3.5 |
| Nextra ™* | 24.2 | 28.8 | 0.4 | 21.8 | 11.3 | 2.6 | 22.6 | 0.3 | 5.9 | 16.9 | 0.3 | 6.8 | 15.5 | 0.3 | 2.3 | 16.0 | 0.3 | 2.6 |
| Sunflower | 16.2 | 28.5 | 0.5 | 13.9 | 11.1 | 2.7 | 14.7 | 0.0 | 6.0 | 8.9 | 0.0 | 6.9 | 7.5 | 0.0 | 2.4 | 8.1 | 0.0 | 2.8 |
| NuSun ™** | 15.5 | 29.3 | 0.4 | 13.1 | 11.8 | 2.6 | 13.9 | 0.8 | 5.9 | 8.1 | 0.8 | 6.8 | 6.8 | 0.8 | 2.3 | 7.3 | 0.8 | 2.7 |
| Corn | 16.8 | 28.5 | 0.6 | 14.5 | 11.1 | 2.8 | 15.3 | 0.0 | 6.1 | 9.5 | 0.0 | 7.0 | 8.1 | 0.0 | 2.5 | 8.7 | 0.0 | 2.9 |
| Cottonseed | 20.2 | 28.5 | 0.5 | 17.9 | 11.1 | 2.7 | 18.7 | 0.0 | 5.9 | 12.9 | 0.0 | 6.8 | 11.5 | 0.0 | 2.3 | 12.1 | 0.0 | 2.7 |
| Palm | 26.0 | 28.5 | 0.5 | 23.6 | 11.1 | 2.7 | 24.4 | 0.0 | 5.9 | 18.6 | 0.0 | 6.8 | 17.3 | 0.0 | 2.3 | 17.8 | 0.0 | 2.7 |
| 50%/50% | | | | | | | | | | | | | | | | | | |
| PHSO† | 17.6 | 38.0 | 0.5 | 16.0 | 26.4 | 2.0 | 16.6 | 19.0 | 4.2 | 12.7 | 19.0 | 4.8 | 11.8 | 19.0 | 1.8 | 12.2 | 19.0 | 2.0 |
| W. PHSO†† | 16.0 | 26.4 | 2.0 | 14.5 | 14.8 | 3.4 | 15.0 | 7.4 | 5.6 | 11.1 | 7.4 | 6.2 | 10.2 | 7.4 | 3.2 | 10.6 | 7.4 | 3.5 |
| Soybean | 16.6 | 19.0 | 4.2 | 15.0 | 7.4 | 5.6 | 15.5 | 0.0 | 7.8 | 11.7 | 0.0 | 8.4 | 10.8 | 0.0 | 5.4 | 11.1 | 0.0 | 5.7 |
| Canola | 12.7 | 19.0 | 4.8 | 11.1 | 7.4 | 6.2 | 11.7 | 0.0 | 8.4 | 7.8 | 0.0 | 9.0 | 6.9 | 0.0 | 6.0 | 7.3 | 0.0 | 6.3 |
| Canola CV65‡ | 11.8 | 19.0 | 1.8 | 10.2 | 7.4 | 3.2 | 10.8 | 0.0 | 5.4 | 6.9 | 0.0 | 6.0 | 6.0 | 0.0 | 3.0 | 6.4 | 0.0 | 3.3 |
| Canola HO [symbol] | 12.2 | 19.0 | 2.0 | 10.6 | 7.4 | 3.5 | 11.1 | 0.0 | 5.7 | 7.3 | 0.0 | 6.3 | 6.4 | 0.0 | 3.3 | 6.7 | 0.0 | 3.5 |
| Nextra ™* | 30.8 | 19.5 | 0.3 | 29.2 | 7.9 | 1.7 | 29.8 | 0.5 | 3.9 | 25.9 | 0.5 | 4.5 | 25.0 | 0.5 | 1.5 | 25.4 | 0.5 | 1.8 |
| Sunflower | 14.9 | 19.0 | 0.5 | 13.3 | 7.4 | 2.0 | 13.8 | 0.0 | 4.2 | 10.0 | 0.0 | 4.8 | 9.1 | 0.0 | 1.8 | 9.4 | 0.0 | 2.0 |
| NuSun ™** | 13.4 | 20.5 | 0.4 | 11.8 | 8.9 | 1.8 | 12.3 | 1.5 | 4.0 | 8.5 | 1.5 | 4.6 | 7.6 | 1.5 | 1.6 | 7.9 | 1.5 | 1.9 |
| Corn | 16.1 | 19.0 | 0.7 | 14.5 | 7.4 | 2.2 | 15.0 | 0.0 | 4.4 | 11.2 | 0.0 | 5.0 | 10.3 | 0.0 | 2.0 | 10.6 | 0.0 | 2.2 |
| Cottonseed | 22.9 | 19.0 | 0.4 | 21.3 | 7.4 | 1.9 | 21.8 | 0.0 | 4.1 | 18.0 | 0.0 | 4.7 | 17.1 | 0.0 | 1.7 | 17.4 | 0.0 | 1.9 |
| Palm | 34.4 | 19.0 | 0.4 | 32.8 | 7.4 | 1.9 | 33.3 | 0.0 | 4.1 | 29.5 | 0.0 | 4.7 | 28.6 | 0.0 | 1.7 | 28.9 | 0.0 | 1.9 |
| 75%/25% | | | | | | | | | | | | | | | | | | |
| PHSO† | 0.0 | 0.0 | 0.0 | 0.0 | 0.0 | 0.9 | 0.0 | 0.0 | 2.0 | 0.0 | 0.0 | 2.3 | 0.0 | 0.0 | 0.8 | 0.0 | 0.0 | 0.9 |
| W. PHSO†† | 0.0 | 0.0 | 0.0 | 0.0 | 0.0 | 0.9 | 0.0 | 0.0 | 2.0 | 0.0 | 0.0 | 2.3 | 0.0 | 0.0 | 0.8 | 0.0 | 0.0 | 0.9 |
| Soybean | 0.0 | 0.0 | 0.0 | 0.0 | 0.0 | 0.9 | 0.0 | 0.0 | 2.0 | 0.0 | 0.0 | 2.3 | 0.0 | 0.0 | 0.8 | 0.0 | 0.0 | 0.9 |
| Canola | 0.0 | 0.0 | 0.0 | 0.0 | 0.0 | 0.9 | 0.0 | 0.0 | 2.0 | 0.0 | 0.0 | 2.3 | 0.0 | 0.0 | 0.8 | 0.0 | 0.0 | 0.9 |
| Canola CV65‡ | 0.0 | 0.0 | 0.0 | 0.0 | 0.0 | 0.9 | 0.0 | 0.0 | 2.0 | 0.0 | 0.0 | 2.3 | 0.0 | 0.0 | 0.8 | 0.0 | 0.0 | 0.9 |
| Canola HO [symbol] | 0.0 | 0.0 | 0.0 | 0.0 | 0.0 | 0.9 | 0.0 | 0.0 | 2.0 | 0.0 | 0.0 | 2.3 | 0.0 | 0.0 | 0.8 | 0.0 | 0.0 | 0.9 |
| Nextra ™* | 0.0 | 0.0 | 0.0 | 0.0 | 0.0 | 0.9 | 0.0 | 0.0 | 2.0 | 0.0 | 0.0 | 2.3 | 0.0 | 0.0 | 0.8 | 0.0 | 0.0 | 0.9 |
| Sunflower | 0.0 | 0.0 | 0.0 | 0.0 | 0.0 | 0.9 | 0.0 | 0.0 | 2.0 | 0.0 | 0.0 | 2.3 | 0.0 | 0.0 | 0.8 | 0.0 | 0.0 | 0.9 |
| NuSun ™** | 0.0 | 0.0 | 0.0 | 0.0 | 0.0 | 0.9 | 0.0 | 0.0 | 2.0 | 0.0 | 0.0 | 2.3 | 0.0 | 0.0 | 0.8 | 0.0 | 0.0 | 0.9 |
| Corn | 0.0 | 0.0 | 0.0 | 0.0 | 0.0 | 0.9 | 0.0 | 0.0 | 2.0 | 0.0 | 0.0 | 2.3 | 0.0 | 0.0 | 0.8 | 0.0 | 0.0 | 0.9 |
| Cottonseed | 0.0 | 0.0 | 0.0 | 0.0 | 0.0 | 0.9 | 0.0 | 0.0 | 2.0 | 0.0 | 0.0 | 2.3 | 0.0 | 0.0 | 0.8 | 0.0 | 0.0 | 0.9 |
| Palm | 0.0 | 0.0 | 0.0 | 0.0 | 0.0 | 0.9 | 0.0 | 0.0 | 2.0 | 0.0 | 0.0 | 2.3 | 0.0 | 0.0 | 0.8 | 0.0 | 0.0 | 0.9 |
| | Nextra ™* | | | Sunflower | | | NuSun ™** | | | Corn | | | Cottonseed | | | Palm | | |
| | SF | TF | 18:3 | SF | TF | 18:3 | SF | TF | 18:3 | SF | TF | 18:3 | SF | TF | 18:3 | SF | TF | 18:3 |
| 25%/75% | | | | | | | | | | | | | | | | | | |
| PHSO† | 37.4 | 10.3 | 0.1 | 13.5 | 9.5 | 0.5 | 11.2 | 11.8 | 0.3 | 15.3 | 9.5 | 0.8 | 25.5 | 9.5 | 0.4 | 42.7 | 9.5 | 0.4 |
| W. PHSO†† | 36.6 | 4.4 | 0.9 | 12.7 | 3.7 | 1.2 | 10.4 | 5.9 | 1.0 | 14.5 | 3.7 | 1.5 | 24.7 | 3.7 | 1.1 | 41.9 | 3.7 | 1.1 |
| Soybean | 36.9 | 0.8 | 2.0 | 13.0 | 0.0 | 2.3 | 10.7 | 2.3 | 2.1 | 14.8 | 0.0 | 2.6 | 25.0 | 0.0 | 2.2 | 42.2 | 0.0 | 2.2 |
| Canola | 35.0 | 0.8 | 2.3 | 11.0 | 0.0 | 2.6 | 8.8 | 2.3 | 2.4 | 12.8 | 0.0 | 2.9 | 23.0 | 0.0 | 2.5 | 40.3 | 0.0 | 2.5 |
| Canola CV65‡ | 34.5 | 0.8 | 0.8 | 10.6 | 0.0 | 1.1 | 8.3 | 2.3 | 0.9 | 12.4 | 0.0 | 1.4 | 22.6 | 0.0 | 1.0 | 39.8 | 0.0 | 1.0 |
| Canola HO [symbol] | 34.7 | 0.8 | 0.9 | 10.8 | 0.0 | 1.3 | 8.5 | 2.3 | 1.0 | 12.6 | 0.0 | 1.6 | 22.8 | 0.0 | 1.1 | 40.0 | 0.0 | 1.1 |
| Nextra ™* | 44.0 | 1.0 | 0.0 | 20.1 | 0.3 | 0.4 | 17.8 | 2.5 | 0.2 | 21.9 | 0.3 | 0.7 | 32.1 | 0.3 | 0.2 | 49.3 | 0.3 | 0.2 |
| Sunflower | 36.0 | 0.8 | 0.1 | 12.1 | 0.0 | 0.5 | 9.9 | 2.3 | 0.3 | 13.9 | 0.0 | 0.8 | 24.1 | 0.0 | 0.4 | 41.4 | 0.0 | 0.4 |
| NuSun ™** | 35.3 | 1.5 | 0.1 | 11.4 | 0.8 | 0.4 | 9.1 | 3.0 | 0.2 | 13.2 | 0.8 | 0.7 | 23.4 | 0.8 | 0.3 | 40.6 | 0.8 | 0.3 |
| Corn | 36.6 | 0.8 | 0.2 | 12.7 | 0.0 | 0.6 | 10.5 | 2.3 | 0.4 | 14.5 | 0.0 | 0.9 | 24.7 | 0.0 | 0.5 | 42.0 | 0.0 | 0.5 |
| Cottonseed | 40.0 | 0.8 | 0.1 | 16.1 | 0.0 | 0.5 | 13.9 | 2.3 | 0.2 | 17.9 | 0.0 | 0.8 | 28.1 | 0.0 | 0.3 | 45.4 | 0.0 | 0.3 |
| Palm | 45.8 | 0.8 | 0.1 | 21.9 | 0.0 | 0.5 | 19.6 | 2.3 | 0.2 | 23.7 | 0.0 | 0.8 | 33.9 | 0.0 | 0.3 | 51.1 | 0.0 | 0.3 |
| 50%/50% | | | | | | | | | | | | | | | | | | |
| PHSO† | 30.8 | 19.5 | 0.3 | 14.9 | 19.0 | 0.5 | 13.4 | 20.5 | 0.4 | 16.1 | 19.0 | 0.7 | 22.9 | 19.0 | 0.4 | 34.4 | 19.0 | 0.4 |
| W. PHSO†† | 29.2 | 7.9 | 1.7 | 13.3 | 7.4 | 2.0 | 11.8 | 8.9 | 1.8 | 14.5 | 7.4 | 2.2 | 21.3 | 7.4 | 1.9 | 32.8 | 7.4 | 1.9 |
| Soybean | 29.8 | 0.5 | 3.9 | 13.8 | 0.0 | 4.2 | 12.3 | 1.5 | 4.0 | 15.0 | 0.0 | 4.4 | 21.8 | 0.0 | 4.1 | 33.3 | 0.0 | 4.1 |
| Canola | 25.9 | 0.5 | 4.5 | 10.0 | 0.0 | 4.8 | 8.5 | 1.5 | 4.6 | 11.2 | 0.0 | 5.0 | 18.0 | 0.0 | 4.7 | 29.5 | 0.0 | 4.7 |
| Canola CV65‡ | 25.0 | 0.5 | 1.5 | 9.1 | 0.0 | 1.8 | 7.6 | 1.5 | 1.6 | 10.3 | 0.0 | 2.0 | 17.1 | 0.0 | 1.7 | 28.6 | 0.0 | 1.7 |
| Canola HO [symbol] | 25.4 | 0.5 | 1.8 | 9.4 | 0.0 | 2.0 | 7.9 | 1.5 | 1.9 | 10.6 | 0.0 | 2.2 | 17.4 | 0.0 | 1.9 | 28.9 | 0.0 | 1.9 |
| Nextra ™* | 44.0 | 1.0 | 0.0 | 28.1 | 0.5 | 0.3 | 26.6 | 2.0 | 0.1 | 29.3 | 0.5 | 0.5 | 36.1 | 0.5 | 0.2 | 47.6 | 0.5 | 0.2 |
| Sunflower | 28.1 | 0.5 | 0.3 | 12.1 | 0.0 | 0.5 | 10.6 | 1.5 | 0.4 | 13.3 | 0.0 | 0.7 | 20.1 | 0.0 | 0.4 | 31.6 | 0.0 | 0.4 |
| NuSun ™** | 26.6 | 2.0 | 0.1 | 10.6 | 1.5 | 0.4 | 9.1 | 3.0 | 0.2 | 11.8 | 1.5 | 0.6 | 18.6 | 1.5 | 0.3 | 30.1 | 1.5 | 0.3 |
| Corn | 29.3 | 0.5 | 0.5 | 13.3 | 0.0 | 0.7 | 11.8 | 1.5 | 0.6 | 14.5 | 0.0 | 0.9 | 21.3 | 0.0 | 0.6 | 32.8 | 0.0 | 0.6 |
| Cottonseed | 36.1 | 0.5 | 0.2 | 20.1 | 0.0 | 0.4 | 18.6 | 1.5 | 0.3 | 21.3 | 0.0 | 0.6 | 28.1 | 0.0 | 0.3 | 39.6 | 0.0 | 0.3 |
| Palm | 47.6 | 0.5 | 0.2 | 31.6 | 0.0 | 0.4 | 30.1 | 1.5 | 0.3 | 32.8 | 0.0 | 0.6 | 39.6 | 0.0 | 0.3 | 51.1 | 0.0 | 0.3 |
| 75%/25% | | | | | | | | | | | | | | | | | | |
| HSO† | 0.0 | 0.0 | 0.0 | 0.0 | 0.0 | 0.1 | 0.0 | 0.0 | 0.1 | 0.0 | 0.0 | 0.2 | 0.0 | 0.0 | 0.1 | 0.0 | 0.0 | 0.1 |
| W. PHSO†† | 0.0 | 0.0 | 0.0 | 0.0 | 0.0 | 0.1 | 0.0 | 0.0 | 0.1 | 0.0 | 0.0 | 0.2 | 0.0 | 0.0 | 0.1 | 0.0 | 0.0 | 0.1 |
| Soybean | 0.0 | 0.0 | 0.0 | 0.0 | 0.0 | 0.1 | 0.0 | 0.0 | 0.1 | 0.0 | 0.0 | 0.2 | 0.0 | 0.0 | 0.1 | 0.0 | 0.0 | 0.1 |
| Canola | 0.0 | 0.0 | 0.0 | 0.0 | 0.0 | 0.1 | 0.0 | 0.0 | 0.1 | 0.0 | 0.0 | 0.2 | 0.0 | 0.0 | 0.1 | 0.0 | 0.0 | 0.1 |
| Canola CV65‡ | 0.0 | 0.0 | 0.0 | 0.0 | 0.0 | 0.1 | 0.0 | 0.0 | 0.1 | 0.0 | 0.0 | 0.2 | 0.0 | 0.0 | 0.1 | 0.0 | 0.0 | 0.1 |
| Canola HO [symbol] | 0.0 | 0.0 | 0.0 | 0.0 | 0.0 | 0.1 | 0.0 | 0.0 | 0.1 | 0.0 | 0.0 | 0.2 | 0.0 | 0.0 | 0.1 | 0.0 | 0.0 | 0.1 |
| Nextra ™* | 0.0 | 0.0 | 0.0 | 0.0 | 0.0 | 0.1 | 0.0 | 0.0 | 0.1 | 0.0 | 0.0 | 0.2 | 0.0 | 0.0 | 0.1 | 0.0 | 0.0 | 0.1 |
| Sunflower | 0.0 | 0.0 | 0.0 | 0.0 | 0.0 | 0.1 | 0.0 | 0.0 | 0.1 | 0.0 | 0.0 | 0.2 | 0.0 | 0.0 | 0.1 | 0.0 | 0.0 | 0.1 |
| NuSun ™** | 0.0 | 0.0 | 0.0 | 0.0 | 0.0 | 0.1 | 0.0 | 0.0 | 0.1 | 0.0 | 0.0 | 0.2 | 0.0 | 0.0 | 0.1 | 0.0 | 0.0 | 0.1 |
| Corn | 0.0 | 0.0 | 0.0 | 0.0 | 0.0 | 0.1 | 0.0 | 0.0 | 0.1 | 0.0 | 0.0 | 0.2 | 0.0 | 0.0 | 0.1 | 0.0 | 0.0 | 0.1 |
| Cottonseed | 0.0 | 0.0 | 0.0 | 0.0 | 0.0 | 0.1 | 0.0 | 0.0 | 0.1 | 0.0 | 0.0 | 0.2 | 0.0 | 0.0 | 0.1 | 0.0 | 0.0 | 0.1 |
| Palm | 0.0 | 0.0 | 0.0 | 0.0 | 0.0 | 0.1 | 0.0 | 0.0 | 0.1 | 0.0 | 0.0 | 0.2 | 0.0 | 0.0 | 0.1 | 0.0 | 0.0 | 0.1 |

Key
SF = Saturated Fat
TF = Trans-Fat
18:3 = levels of linolenic acid (“18:3” = 18 carbons and 3 double bonds)
†= Partially Hydrogenated Soybean Oil
††= Winterized Partially Hydrogenated Soybean Oil
‡= Clear Valley 65 ™- High Oleic Canola Oil manufactured by Cargill [symbol]
= High Oleic Canola Oil
*= Tallow/Vegetable Mixture manufactured by Source Food Technology, Inc. (previously known as Appetize ™)
**= Mid-oleic Sunflower Oil

Similarly, the use of a blend of palm oil with NuSun™, as mentioned above, can provide a higher crystallization temperature than NuSun™ alone and as shown in the Table, also exhibiting reduced saturated fat and trans-fat levels. Additionally, a 50/50 blend of palm oil and NuSun™ has a crystallization temperature of about 35° C. or 90° F. to provide reduced trans-fat levels with crystallization temperatures high enough (i.e., initiating solidification of the oil at temperatures equal to or greater than 10° F.) to prevent clumping during freezing and melting during high volume storage loading. Thus, a blend of palm oil with NuSun™ would be desirable.

Corn oil, although not illustrated in FIGS. 1 and 2, can also be used in a blend with NuSun™; however, corn oil has a low crystallization temperature, and may not reduce clumping levels sufficiently to provide a desirable solution. Moreover, corn oil (unlike sunflower oil, cottonseed oil, and palm oil) can have a relatively lower smoking temperature resulting in smoke formation during normal manufacturing procedures.

Sunflower oil, cottonseed oil, and palm oil tend to be miscible with one another and therefore do not tend to separate during par frying, freezing in a freeze tunnel or freezing during frozen storage. Thus, the lower crystallization temperature of sunflower oil does not tend to cause clumping when blended with the other oils, which can be selected from the group of cottonseed and/or palm oil.

Similarly, sunflower oil and cottonseed and/or palm oil can be blended adequately enough to react as one oil due to their miscibility. Thus, upon freezing, the cottonseed and/or palm oil with their higher crystallization temperatures can be frozen and can remain frozen such as to reduce clumping that could otherwise be present if pure sunflower oil were utilized.

To balance the crystallization temperature with the reduction of trans-fat levels, a blend of oils is desired. For example, a blend of about 50/50 sunflower oil and a second oil of selected from the group consisting of cottonseed oil and palm oil is preferred. By providing a 50/50 blend, the blend provides a stable frying oil, and can balance an increased crystallization temperature with reduced trans-fat levels, as well as provide reduced clumping during frozen storage. It is noted that variations from 50/50 ratio (e.g., from about 40 to about 60% of each oil within the blended oil) is contemplated herein.

In addition to the manufacturing benefits and clumping reduction from the use of the blends, aesthetic benefits can also be realized. Frozen potato products par fried in NuSun™ oil alone look fresher and more appealing than, for example, frozen potato products par fried in partially hydrogenated soy-containing oil. For example, frozen potato products par fried in NuSun™ appear bright and clear, albeit oilier; while frozen potato products par fried in partially hydrogenated soy-containing oil appear dull and cloudy. Thus, the use of NuSun™ with frozen potato products is also desirable for aesthetic reasons.

### EXAMPLE

In an exemplary embodiment, a blend of about 50% NuSun™ and about 50% cottonseed oil are provided in a vat. These oils can be: provided individually and mixed within the vat, pre-blended with the blend provided in the vat, pumped in together via separate pipes, etc. These oils can also be held at temperatures above the crystallization temperatures of all of the oils used, and can be provided with a mixer (e.g., a mechanical arm, magnetic stirrer, etc.) to keep the blend mixed.

This blend is heated and potatoes, which can be provided in a number of various forms, such as french fries, tater tots, etc., are par fried therein. After par frying, the potatoes with the blend of oil thereon/therein pass through a freeze tunnel at about 10° F. to about 25° F. to freeze the potatoes and also to crystallize the cottonseed oil.

Next, the frozen potato products can be wrapped in packages or can be loaded into a bin, wherein the cottonseed oil and the potato products can remain frozen. A typical bin is 4′×4′×4′ and can accommodate about 1000 to about 1500 pounds of frozen potato products.

After filling the bin or the wrapped packages, the bin or the wrapped packages can then be placed into frozen storage at about 0° F., wherein the sunflower oil can crystallize, and wherein clumping is reduced because only the sunflower oil will crystallize during frozen storage. Thus, by providing a blend like this, the following advantages can be achieved: reduced trans-fat levels, reduced clumping, and sufficient miscibility of the blend of oils during cooking and freezing to produce a superior frozen potato product.

The term “about” as used here indicates that associated numerical values are not intended to be precise but are intended to have a tolerance of 5% above and below any stated numerical value.

It will now be apparent to those skilled in the art that a novel process for preparing potato products with reduced trans-fat levels has been described. Moreover, it will also be apparent to those skilled in the art that numerous modifications, variations, substitutions and equivalents exist for features of the invention which do not materially depart from the spirit and scope of the invention as defined in the appended claims. Accordingly, it is expressly intended that all such modifications, variations, substitutions and equivalents that fall within the spirit and scope of the appended claims be embraced thereby.

What is claimed is:

1. A process for producing frozen potato products having reduced trans-fat levels comprising the steps of:
providing a stable frying oil with an 18:3 ratio of <2 wt % and a trans-fat level of <3 wt %;
par frying potatoes in the blend to produce potato products; and
freezing the potato products to produce frozen potato products having reduced trans-fat levels, wherein ≧50% of the oil remaining in and on the frozen potato products freezes at temperatures ≧10° F.

2. The process according to claim 1, wherein the oil consists essentially of about 50% of a first oil and about 50% of a second oil.

3. A process for producing frozen potato products having reduced trans-fat levels comprising the steps of:
providing a blend of oil consisting essentially of a first oil and a second oil, wherein the first oil consists essentially of sunflower oil and wherein the second oil consists essentially of cottonseed and/or palm oil;
par frying potatoes in the blend to produce potato products; and
freezing the potato products to produce frozen potato products having reduced trans-fat levels.

4. The process according to claim 3, wherein the blend consists essentially of about 50% of a first oil and about 50% of a second oil.

5. A process for providing frozen potato products having reduced trans-fat levels and reduced clumping comprising the steps of:
providing a blend of sunflower oil and a second oil, wherein the crystallization temperature of the second oil is greater than about 25° F.;
par frying potatoes in the blend to produce potato products; and
freezing the potato products to provide frozen potato products having reduced trans-fat levels and reduced clumping.

6. The process according to claim 5, wherein the second oil consists essentially of cottonseed oil and/or palm oil.

7. The process according to claim 5, wherein the oil blend consists essentially of about 50% sunflower oil and about 50% cottonseed oil.

8. The process according to claim 5, wherein the oil blend consists essentially of about 50% sunflower oil and about 50% palm oil.

9. The process according to claim 5, wherein the oil blend reduces clumping of the potato products.

10. The process according to claim 5, wherein the sunflower oil and the second oil are miscible.

11. The process according to claim 5, wherein blend of sunflower oil and second oil has zero trans-fat.

12. The process according to claim 5, wherein the sunflower oil comprises NuSun™.

13. The process according to claim 5, wherein the crystallization temperature of the second oil is greater than about 32° F.

14. The process according to claim 5, wherein the crystallization temperature of the second oil is at least about 50° F.

15. The process according to claim 5, wherein the crystallization temperature of the blend of sunflower oil and the second oil is at least about 32° F.
